(19) United States
(12) Patent Application Publication
(10) Pub. No.: US 2024/0003846 A1
(43) Pub. Date: Jan. 4, 2024

(54) Methods For Detection Of Isomeric Steroids Using Differential Mobility Spectrometry

(71) Applicant: DH Technologies Development Pte. Ltd., Singapore (SG)

(72) Inventors: John Lawrence Campbell, Newmarket (CA); Subhasish PURKAYASTHA, Concord (CA)

(21) Appl. No.: 18/036,098

(22) PCT Filed: Nov. 9, 2021
(86) PCT No.: PCT/IB21/60368

§ 371 Date: May 9, 2023

Related U.S. Application Data
(60) Provisional application No. 63/112,435, filed on Nov. 11, 2020.

(51) Int. Cl. G01N 27/624

(52) U.S. Cl. CPC G01N 27/624

(57) ABSTRACT

Method for separating, detecting, and/or quantifying steroid isomers using differential mobility spectrometry (DMS) are provided herein. In accordance with various aspects of the applicant's teachings, the method can provide for the separation of racemic or non-racemic mixtures of steroid isomers that may be difficult to separate with conventional techniques, such as mass spectrometry (MS), including both steroid stereoisomers and constitutional steroid isomers. The method may further comprise detecting the ionized derivatized steroids transported from the differential mobility spectrometer at a first combination of compensation voltage and separation voltage and at a second combination of compensation voltage and separation voltage applied to the differential mobility spectrometer, wherein the first combination is configured to optimize transmission of a first ionized derivatized steroid corresponding to a first steroid of an isomeric steroid pair and the second combination is configured to optimize transmission of a second ionized derivatized steroid corresponding to a second steroid of the isomeric steroid pair.

### RELATED APPLICATIONS

This application claims priority to U.S. provisional application No. 63/112,435 filed on Nov. 11, 2020, entitled “Methods for Detection of Isomeric Steroids Using Differential Mobility Spectrometry,” which is incorporated herein by reference in its entirety.

### FIELD

The present teachings generally relate to methods and systems utilizing differential mobility spectrometry (DMS) to identify, quantify, separate, and/or detect isomeric steroids.

### BACKGROUND

Mass spectrometry (MS) is an analytical technique for determining the elemental composition of test substances with both qualitative and quantitative applications. MS can be useful for identifying unknown compounds, determining the isotopic composition of elements in a molecule, determining the structure of a particular compound by observing its fragmentation, and quantifying the amount of a particular compound in a sample. Given its sensitivity and selectivity, MS is particularly important in life science applications.

Though steroids (e.g., estrogens, progesterone, testosterone) make up an important class of hormones, separating and detecting isomeric steroids from one another remains an ongoing challenge in analytical chemistry using conventional mass spectrometric methods. By way of example, conventional mass spectrometry techniques may be unable to resolve isomeric steroids due to their identical mass-to-charge ratios. Thus, isomeric steroids, which have the same chemical formula but differ structurally (e.g., constitutional isomers) or spatially (e.g., stereoisomers), may require additional sample preparation processes (e.g., reversed-phase liquid chromatography (RPLC)) prior to mass spectrometric analysis, thereby reducing throughput and/or costs. In addition, the ionization efficiency and sensitivity of detection for many steroids may be limited by the weak basicity of these compounds, their tendency to undergo in-source fragmentation, and the lack of unique diagnostic fragment ions for each steroid (i.e., common fragmentation pathways are common for many steroids).

Accordingly, there remains a need for improved methods and systems for the separation and detection of steroids.

### SUMMARY

The present teachings provide methods and systems that utilize differential mobility spectrometry (DMS) to analyze a sample containing or suspected of containing one or more isomeric steroids in a sample. In some particular aspects, the methods and systems described herein may be able to distinguish between isomeric steroids that have been derivatized prior to ionization, for example, without having to subject the sample to conventional time-consuming sample preparation steps such as in-line liquid chromatography as in LC-MS. As such, in certain aspects, steroid analytes that may otherwise be difficult to resolve using conventional mass spectrometric techniques may be identified based on their different mobility characteristics and/or separated prior to mass spectrometric analysis.

Methods and systems for the identification and/or quantification of steroid isomers using differential mobility spectrometry (DMS) are provided herein. In accordance with various aspects of the present teachings, a method of analyzing a sample containing or suspected of containing at least one isomeric steroid, comprising: reacting, if present, each isomeric steroid with a derivatizing reagent so as to form derivatized steroids corresponding to each isomeric steroid. The derivatized may be ionized so as to form ionized derivatized steroids, which may be transported through a differential mobility spectrometer to effect separation of the ionized derivatized steroids corresponding to each isomeric steroid from another isomeric steroid in sample.

In certain aspects, the method may further comprise detecting the ionized derivatized steroids transported from the differential mobility spectrometer at a first combination of compensation voltage and separation voltage and at a second combination of compensation voltage and separation voltage applied to the differential mobility spectrometer, wherein the first combination is configured to optimize transmission of a first ionized derivatized steroid corresponding to a first steroid of an isomeric steroid pair and the second combination is configured to optimize transmission of a second ionized derivatized steroid corresponding to a second steroid of the isomeric steroid pair. In some related aspects, the method may further comprise determining the relative abundance in the sample of the first and second steroids of the isomeric steroid pair.

In some aspects, the sample may contain at least two steroids that are isomers of one another. By way of example, each of the at least two steroids may be constitutional isomers relative to the other or each of the at least two steroids are stereoisomers relative to the other.

A variety of derivatizing agents can be used in accordance with the present teachings. By way of example, the derivatizing reagent may be an acyl halide. In some particular example aspects, the derivatizing reagent may be one of S-(−)-N-(trifluoroacetyl)prolyl chloride and R-(−)-N-(trifluoroacetyl)-propyl chloride. In some alternative aspects, the derivatizing reagent comprises a substituted proline betaine. By way of non-limiting example, the substituted proline betaine may be one of the compounds of the following formulas:

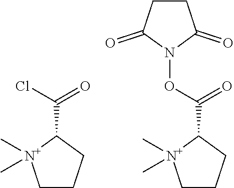

In various aspects, the steroid may comprise a hydroxyl group, wherein the step of reacting each steroid with the derivatizing agent comprises replacing a hydrogen of the hydroxyl group of the steroid with at least a portion of the derivatizing agent.

In certain aspects, a compensation voltage and a separation voltage may be applied to the differential mobility spectrometer so as to selectively transmit one of said ionized derivatized steroids. In some related aspects, the method may comprise scanning the compensation voltage while maintaining the separation voltage. Additionally or alternatively, the method may comprise adjusting at least one of the compensation voltage and the separation voltage after a first duration so as to selectively transmit another of said ionized derivatized steroids for a second duration.

In various aspects, methods in accordance with the present teachings may further comprise adding a chemical modifier to a drift gas for transporting said ionized derivatized steroids through the differential mobility spectrometer. By way of non-limiting examples, the chemical modifier may be selected from the group consisting of water, methanol, isopropanol, acetonitrile, and acetone.

In certain aspects, the differential mobility spectrometer may comprise High-Field Asymmetric Waveform Ion Mobility Spectrometry (FAIMS).

In accordance with various aspects of the present teachings, a method of analyzing a sample containing or suspected of containing at least one steroid of an isomeric steroid pair is provided, the method comprising transporting one or more ionized derivatized steroids each of which is derived from a single steroid of the isomeric steroid pair through a differential mobility spectrometer to effect separation of the one or more ionized derivatized steroids. In some related aspects, the one or more ionized derivatized steroids may comprise a first ionized derivatized steroid corresponding to a first steroid of the isomeric steroid pair and a second ionized derivatized steroid corresponding to a second steroid of the isomeric steroid pair, the method further comprising determining the relative abundance in the sample of the first and second steroids based on the relative abundance of the first and second ionized derivatized steroids following the differential mobility separation.

These and other features of the applicant's teachings are set forth herein.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1 is a schematic representation of an exemplary differential mobility spectrometer/mass spectrometer system in accordance with an aspect of various embodiments of the applicant's teachings.

FIG. 2 is a schematic workflow for analyzing a sample containing or suspected of containing at least one steroid isomer in accordance with various aspects of the present teachings.

FIGS. 3A-C illustrate the chemical structure of example steroid isomers that can be distinguished from one another in accordance with various aspects of the present teachings.

FIGS. 4A-C illustrate the chemical structure of three exemplary derivatizing reagents, namely N-(trifluoroacetyl)prolyl chloride (TPC) (FIG. 4A), proline betaine chloride (PBC) (FIG. 4B) and an ester of proline betaine and N-hydroxysuccinimide (PBNHS) (FIG. 4C), for use in accordance with various aspects of the applicant's teachings.

FIGS. 5A-C schematically depict exemplary reactions of TPC with the steroid isomers of FIGS. 3A-C in accordance with various aspects of the present teachings.

FIGS. 6A-C schematically depict exemplary reactions of PBC with the steroid isomers of FIGS. 3A-C in accordance with various aspects of the present teachings.

FIG. 7A illustrates an exemplary ionogram generated from samples containing TPC-testosterone and/or TPC-epitestosterone during a CoV scan.

FIG. 7B illustrates an exemplary mass spectrum (EPI, enhanced product ion) for the ions transmitted from the DMS operating at CoV≈−2.3 V, from samples containing a mixture of containing TPC-testosterone and TPC-epitestosterone.

FIG. 7C illustrates an exemplary mass spectrum (EPI) for the ions transmitted from the DMS operating at CoV≈−1.9 V, from samples containing a mixture of TPC-testosterone and TPC-epitestosterone.

FIG. 8A illustrates an exemplary ionogram generated from a sample containing a mixture of TPC-testosterone and TPC-epitestosterone and a sample containing TPC-DHEA during a CoV scan.

FIG. 8B illustrates an exemplary mass spectrum (EPI) for the TPC-testosterone ions transmitted from the DMS operating at CoV≈+6.9 V from a sample containing a mixture of TPC-testosterone and TPC-epitestosterone.

FIG. 8C illustrates an exemplary mass spectrum (EPI) for the TPC-DHEA ions transmitted from the DMS operating at CoV≈+9.2 V.

FIG. 8D illustrates an exemplary mass spectrum (EPI) for the TPC-epitestosterone ions transmitted from the DMS operating at CoV≈+13.1 V from a sample containing a mixture of TPC-testosterone and TPC-epitestosterone.

FIG. 8E illustrates an exemplary ionogram and the detected intensity for the unique m/z transitions of FIGS. 8B-D.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

Steroids are an important class of biologically-active compounds, and may be produced naturally within the human body (endogenous steroids) and/or may be synthetically created (e.g., for treatment of various disorders, doping). Whereas conventional mass spectrometric techniques may have difficulty resolving various steroids due to their similar mass-to-charge ratios and/or fragmentation patterns without additional sample preparation steps such as in-line RPLC (e.g., as used in LC-MS), methods and systems in accordance with the present teachings can be used to distinguish a variety of steroids within a single sample (including constitutional steroid isomers and/or steroid stereoisomers) using differential mobility spectrometry (DMS). As discussed in detail below, for example, the present teachings provide for the derivatization of one or more steroid isomers that can be ionized and then separated from one another via DMS based on the ionized derivatized steroids' different mobility characteristics. In various aspects, derivatization may be performed offline (e.g., in a separate step or in parallel with the DMS/MS analysis), thereby increasing throughput relative to a conventional LC-MS analysis in which the various species of steroids are serially analyzed as they elute out of the LC column over time (e.g., over the span of minutes).

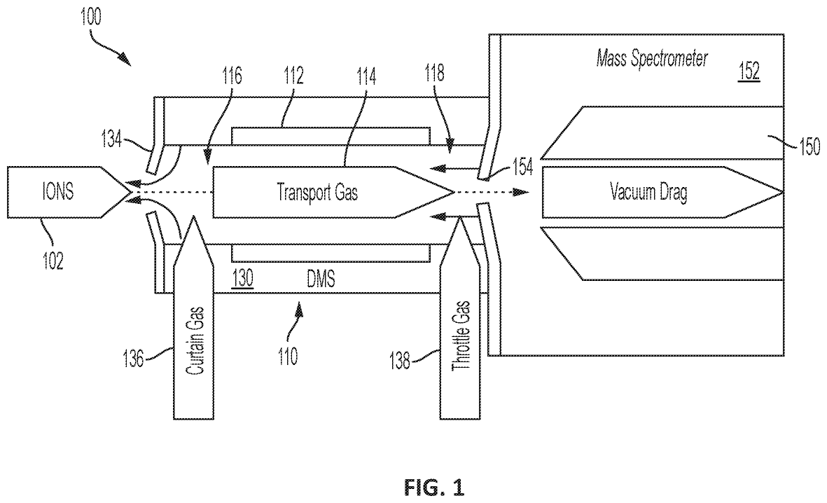

An exemplary system for analyzing and/or quantifying steroid isomers that have been derivatized as otherwise discussed herein is exemplified in FIG. 1. In various aspects, for example, the one or more derivatized steroids (e.g., a mixture comprising multiple derivatized steroids) formed from the reaction of the steroids within a sample with the derivatizing reagent can be subjected to ionization, differential mobility spectrometry, and detection in the system 100, as discussed in detail below. As will be appreciated by a person skilled in the art, the exemplary system 100 represents only one possible configuration for use in accordance with various aspects of the systems, devices, and methods described herein.

As shown in FIG. 1, the exemplary system 100 generally comprises a differential mobility device 110 in fluid communication with a first vacuum lens element 150 of a mass spectrometer (hereinafter generally designated mass spectrometer 150). The differential mobility device 110 can have a variety of configurations, but is generally configured to resolve ions 102 (e.g., the ionized derivatized steroids) based on their mobility through a fixed or variable electric field (whereas MS analyzes ions based on their mass-to-charge ratios). It will be appreciated that though the ion mobility device 110 is commonly described herein as a differential mobility spectrometer, the ion mobility device can be any ion mobility device configured to separate ions based on their mobility through a carrier or drift gas, including by way of non-limiting example, an ion mobility spectrometer, a drift-time ion mobility spectrometer, a traveling-wave ion mobility spectrometer, a differential mobility spectrometer, and a high-field asymmetric waveform ion mobility spectrometer (FAIMS) of various geometries such as parallel plate, curved electrode, or cylindrical FAIMS device, among others. In DMS, RF voltages, often referred to as separation voltages (SV), can be applied across the drift tube in a direction perpendicular to that of a drift gas flow. Ions of a given species tend to migrate radially away from the axis of the transport chamber by a characteristic amount during each cycle of the RF waveform due to differences in mobility during the high field and low field portions. A DC potential, commonly referred to as a compensation voltage (CoV), is applied to the DMS cell and provides a counterbalancing electrostatic force to that of the SV. The CoV can be tuned so as to preferentially prevent the drift of a species of ion of interest. Depending on the application, the CoV can be set to a fixed value to pass only ion species with a particular differential mobility while the remaining species of ions drift toward the electrodes and are neutralized. Alternatively, if the CoV is scanned for a fixed SV as a sample is introduced continuously into the DMS, a mobility spectrum can be produced as the DMS transmits ions of different differential mobilities. Where chromatographic separation in in-line LC-MS typically requires several minutes as the various species of steroids differentially elute from the LC column and the eluate is transported to the ion source, DMS separation of a sample in accordance with the present teachings may be performed within several seconds, for example.

In the exemplary embodiment depicted in FIG. 1, the differential mobility spectrometer 110 is contained within a curtain chamber 130 that is defined by a curtain plate or boundary member 134 and is supplied with a curtain gas 136 from a curtain gas supply (not shown). As shown, the exemplary differential mobility spectrometer 110 comprises a pair of opposed electrode plates 112 that surround a transport gas 114 that drifts from an inlet 116 of the differential mobility spectrometer 110 to an outlet 118 of the differential mobility spectrometer 110. The outlet 118 of the differential mobility spectrometer 110 releases the drift gas 116 into an inlet 154 of a vacuum chamber 152 containing the mass spectrometer 150. A throttle gas 138 can in some aspects additionally be supplied at the outlet 118 of the differential mobility spectrometer 110 so as to modify the flow rate of transport gas 114 through the differential mobility spectrometer 110.

In accordance with certain aspects of the present teachings, the curtain gas 136 and throttle gas 138 can be set to flow rates determined by a flow controller and valves so as to alter the drift time of ions within the differential mobility spectrometer 110. Each of the curtain and throttle gas supplies can provide the same or different pure or mixed composition gas to the curtain gas chamber. By way of non-limiting example, the curtain gas can be air, O₂, He, N₂, or CO₂. The pressure of the curtain chamber 130 can be maintained, for example, at or near atmospheric pressure (i.e., 760 Torr).

Additionally, in some aspects, the system 100 can include a chemical modifier supply (not shown) for supplying a chemical modifier and/or reagent (hereinafter referred as chemical modifier) to the curtain and throttle gases. As will be appreciated by a person skilled in the art, the modifier supply can be a reservoir of a solid, liquid, or gas through which the curtain gas is delivered to the curtain chamber 130. By way of example, the curtain gas can be bubbled through a liquid modifier supply. Alternatively, a modifier liquid or gas can be metered into the curtain gas, for example, through an LC pump, syringe pump, or other dispensing device for dispensing the modifier into the curtain gas at a known rate. For example, the modifier can be introduced using a pump so as to provide a selected concentration of the modifier in the curtain gas. The modifier supply can provide any modifier known in the art including, by way of non-limiting example, water, volatile liquid (e.g., methanol, propanol, acetonitrile, ethanol, acetone, and benzene), including alcohols, alkanes, alkenes, halogenated alkanes and alkenes, furans, esters, ethers, aromatic compounds. As will be appreciated by a person skilled in the art in light of the present teachings, the chemical modifier can interact with the ionized derivatized steroids such that the ions differentially interact with the modifier (e.g., cluster via hydrogen or ionic bonding) during the high and low field portions of the SV, thereby effecting the CoV needed to counterbalance a given SV. In some cases, this can increase the separation between the ionized derivatized steroids.

The derivatized steroids can be subject to ionization by an ion source (not shown) so as to form ionized derivatized steroids 102 that are emitted into the curtain chamber 130 via curtain chamber inlet 150. As will be appreciated by a person skilled in the art, the ion source can be virtually any ion source known in the art, including for example, an electrospray ionization (ESI) source. The pressure of the curtain gases in the curtain chamber 130 (e.g., ˜760 Torr) can provide both a curtain gas outflow out of curtain gas chamber inlet, as well as a curtain gas inflow into the differential mobility spectrometer 110, which inflow becomes the transport gas 114 that carries the ionized derivatized steroids 102 through the differential mobility spectrometer 110 and into the mass spectrometer 150 contained within the vacuum chamber 152, which can be maintained at a much lower pressure than the curtain chamber 130. By way of non-limiting example, the vacuum chamber 152 can be maintained at a pressure lower than that of the curtain chamber 130 (e.g., by a vacuum pump) so as to drag the transport gas 114 and ionized derivatized steroids 102 entrained therein into the inlet 154 of the mass spectrometer 150. It will be appreciated by those skilled in the art in light of the present teachings that the derivatized steroids (or the mixture containing the same) can be delivered to the ion source from a variety of sample sources, including through direct injection, pumping from a reservoir containing a fluid sample, and via a liquid chromatography (LC) column, by way of non-limiting examples. As noted above, however, methods and systems in accordance with various aspects of the present teachings may utilize DMS to provide sufficient resolution of the derivatized steroids within the sample such that an additional in-line separation technique (e.g., LC) is unnecessary prior to ionization.

As will be appreciated by a person skilled in the art, the differential mobility/mass spectrometer system 100 can additionally include one or more additional mass analyzer elements downstream from vacuum chamber 152. Ionized derivatized steroids 102 can be transported through vacuum chamber 152 and through one or more additional differentially pumped vacuum stages containing one or more mass analyzer elements. For instance, in one embodiment, a triple quadrupole mass spectrometer may comprise three differentially pumped vacuum stages, including a first stage maintained at a pressure of approximately 2.3 Torr, a second stage maintained at a pressure of approximately 6 mTorr, and a third stage maintained at a pressure of approximately 10⁻⁵ Torr. The third vacuum stage can contain a detector, as well as two quadrupole mass analyzers with a collision cell located between them. It will be apparent to those skilled in the art that there may be a number of other ion optical elements in the system. Alternatively, a detector (e.g., a Faraday cup or other ion current measuring device) effective to detect the ions transmitted by the differential mobility spectrometer 110 can be disposed directly at the outlet of the differential mobility spectrometer 110. It will be apparent to those skilled in the art that the mass spectrometer employed could take the form of a quadrupole mass spectrometer, triple quadrupole mass spectrometer, time-of-flight mass spectrometer, FT-ICR mass spectrometer, or Orbitrap mass spectrometer, all by way of non-limiting example.

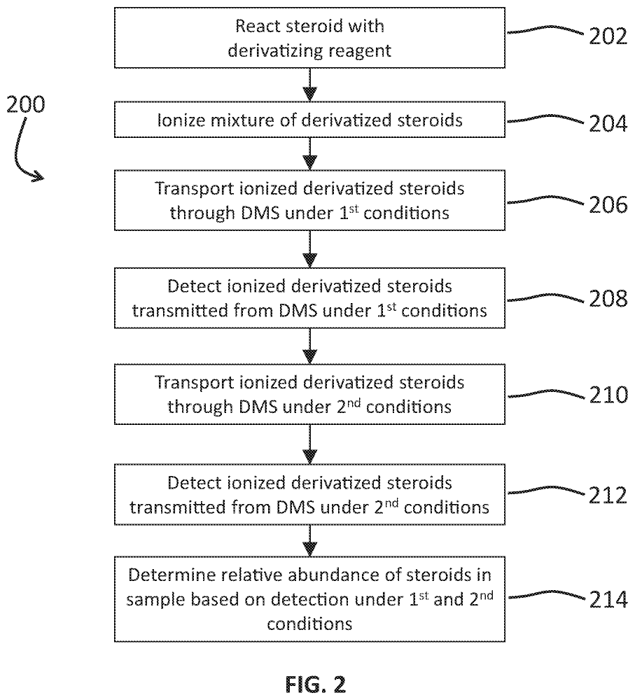

With reference now to FIG. 2, an exemplary method 200 for identifying and/or quantifying steroids within a sample is depicted in accordance with various aspects of the present teachings. As shown in step 202, a sample containing or suspected of containing one or more steroids can be reacted with a derivatizing reagent so as to form derivatized steroids. By way of example, the derivatized steroids can correspond to each steroid isomer of an isomeric pair being covalently bound to at least a portion of the derivatizing reagent.

The steroids to be derivatized can be present in a variety of samples, including, for example, a biological sample. Biological samples can comprise any bodily fluid, such as an intracellular fluid, an extracellular fluid, urine, blood, CSF (cerebrospinal fluid), saliva, bile, amniotic fluid, lymph, etc. The sample can also comprise, for example, a crude sample or a purified sample, and it will be appreciated that one or more additional steps of sample processing can be performed before and/or after step 202, for example, so as to remove contaminants or otherwise purify the steroid isomers within a sample and/or the derivatized steroid reaction products. By way of non-limiting example, any of gas chromatography, liquid chromatography, or capillary electrophoresis can be used to purify the sample prior to step 202 and/or to purify the reaction products prior to further processing as otherwise discussed herein. However, as noted above, in accordance with some aspects of the present teachings, the methods and systems described herein may provide for the analysis of derivatized isomeric steroids without having to subject the sample to in-line liquid chromatography (e.g., RPLC used in LC-MS). Rather, derivatization and further purification, if necessary, may be performed offline (e.g., in a separate step or in parallel with the DMS/MS analysis) so as to avoid tying up valuable mass spectrometer resources as the individual species of steroids serially elute from an LC column.

Steroids are an important class of biologically-active compounds, which may be produced naturally within the human body (endogenous steroids) or may be synthetically created (e.g., for treatment of various disorders, doping). The methods and systems described herein can be used to analyze a variety of endogenous and exogenous steroids, including constitutional steroid isomers and/or steroid stereoisomers. Non-limiting examples of steroid hormones include estrogens (e.g., estrone, estradiol and estriol), progesterones, testosterone, aldosterone, secosteroids (e.g., vitamin D), dehydroepiandrosterone (DHEA), and derivatives thereof. For example, estradiol sulfate (E2S) is an ester derivative of estradiol that serves as a circulating reservoir of estrogen, while 2-hydroxyestradiol is a catechol estrogen that is a constitutional isomer of estriol that interacts with catecholamine systems. Likewise, dehydroepiandrosterone sulphate (DHEAs) is a naturally-occurring metabolite of DHEA that functions as a neurosteroid and neurotrophin, by way of non-limiting example.

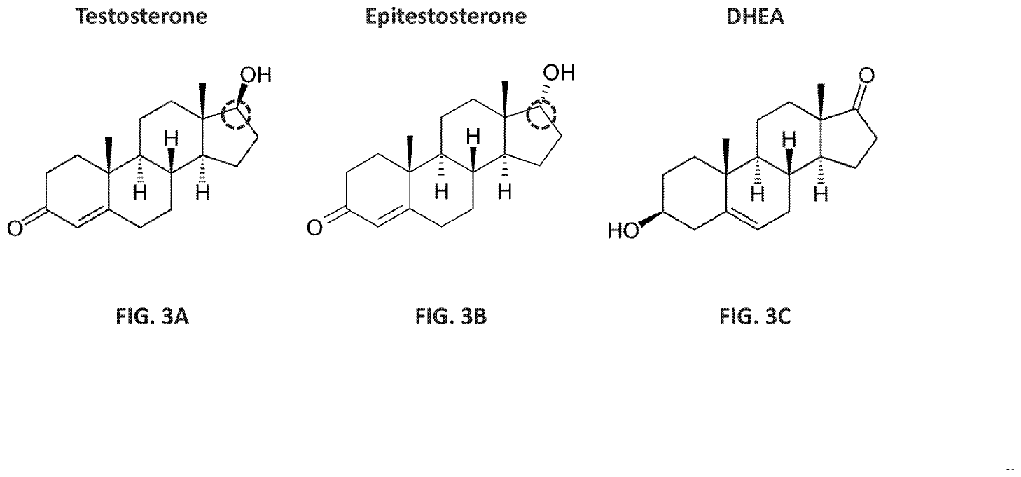

With reference now to FIG. 3A-C, exemplary steroids that can be analyzed in accordance with various aspects of the present teachings are depicted. FIG. 3A depicts the structure of testosterone, FIG. 3B depicts the structure of epitestosterone, and FIG. 3C depicts the structure of DHEA. As will be appreciated by a person skilled in the art, testosterone (FIG. 3A) and epitestosterone (FIG. 3B) are stereoisomers relative to one another because they exhibit the same molecular formula and sequence of bonded atoms, but differ in the spatial distribution of the hydroxyl functional group about the chiral carbon (circled in broken line). While DHEA (FIG. 3C) also exhibits the same molecular formula as testosterone and epitestosterone, DHEA represents a constitutional isomer relative to these because it differs in the bond order and bonding pattern of the functional groups attached to the various rings. For example, in DHEA, the hydroxyl group is bonded to a cyclohexane ring as opposed to the cyclopentane ring as in testosterone and epitestosterone.

The derivatizing reagents can comprise a variety of compounds in accordance with various aspects of the present teachings such that their reaction with the steroid isomer results in a reaction product that can be distinguished from other derivatized steroid isomers as otherwise discussed herein. In some exemplary aspects, the derivatizing agent can comprise a molecule exhibiting a permanent charge and/or a very basic functional group to improve ionization efficiency of the derivatized steroid relative to the underivatized steroid. By way of non-limiting example, some exemplary derivatizing reagents comprise an acyl halide (e.g., N-(trifluoroacetyl)prolyl chloride) or a proline betaine-based derivatizing reagent.

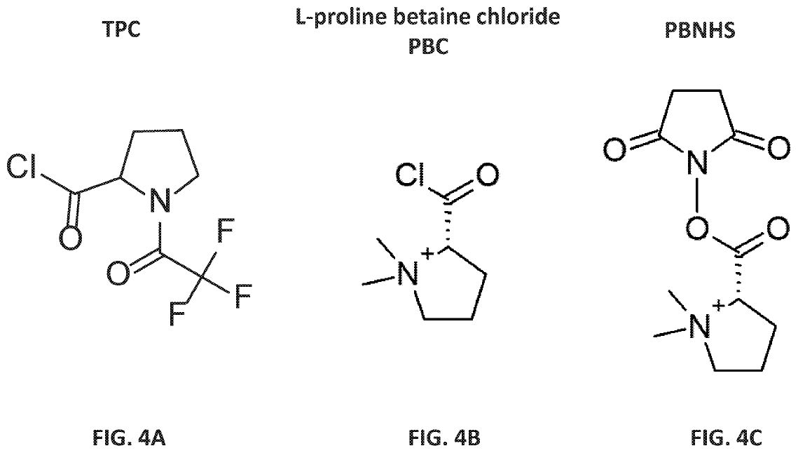

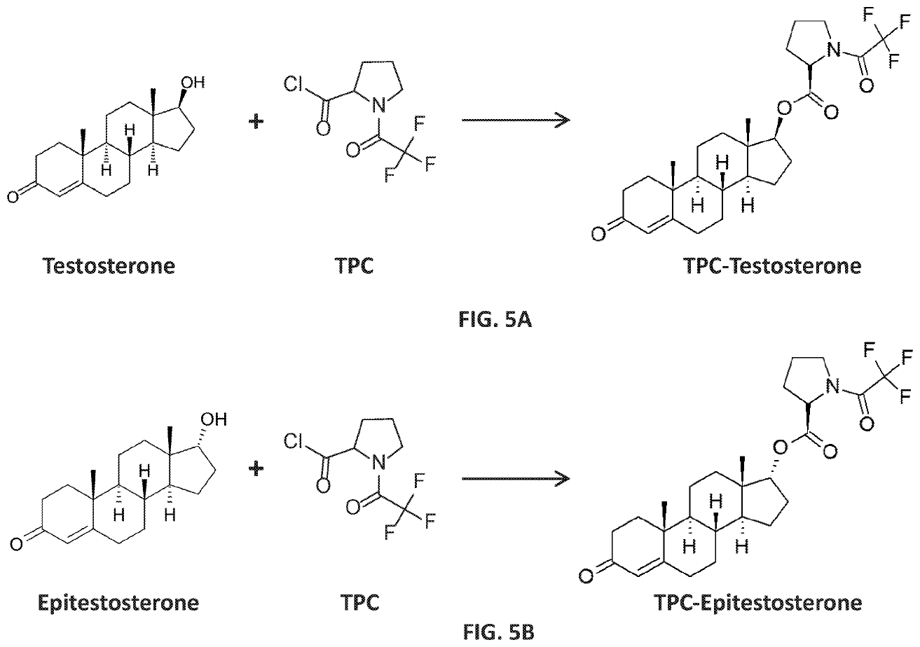

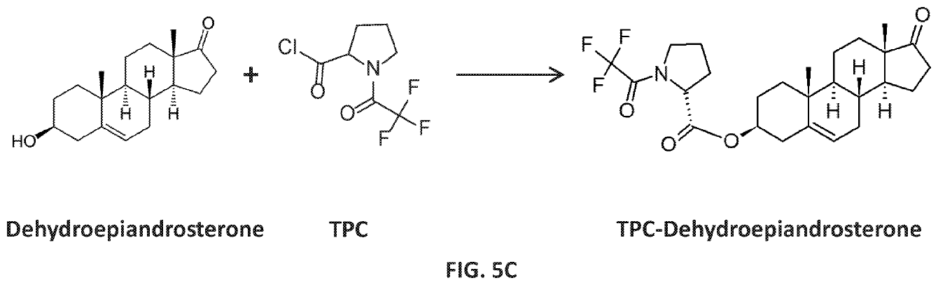

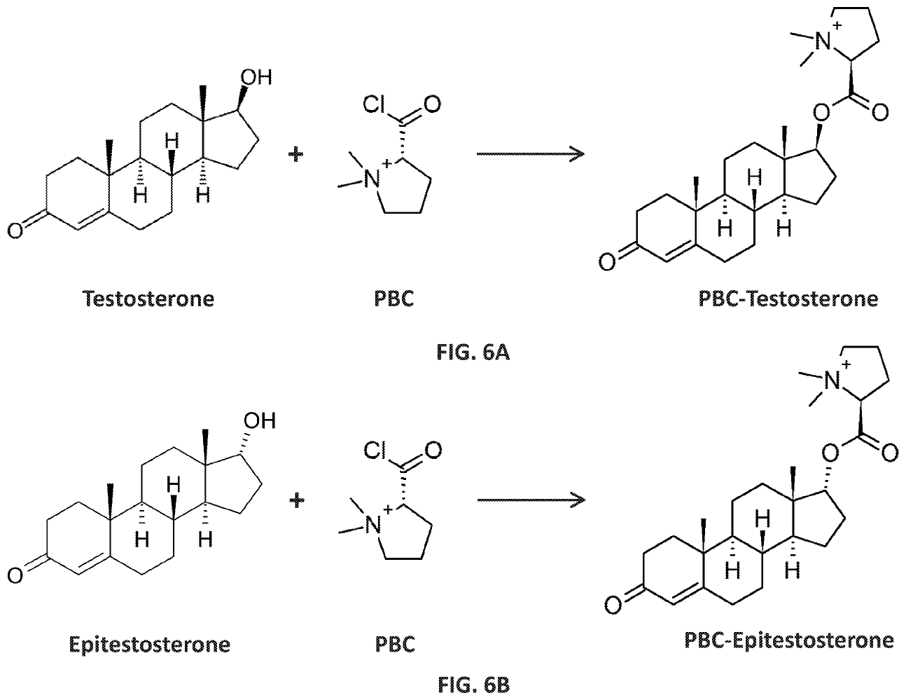

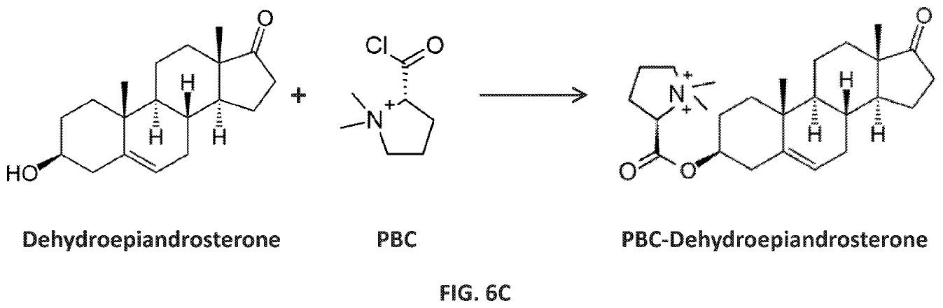

With reference now to FIGS. 4A-C, three exemplary reagents suitable for use as derivatizing reagents in accordance with various aspects of the present teachings are depicted. FIG. 4A depicts the structure of N-(trifluoroacetyl)prolyl chloride, while FIGS. 4B and 4C depict a substituted proline betaines in which an oxygen of the proline betaine is substituted with chlorine (PBC) and an ester of proline betaine and N-hydroxysuccinimide (PBNHS), respectively.

With reference again to the exemplary method of analyzing a sample depicted in FIG. 2, after the steroid(s) (e.g., a pair of isomeric steroids) are reacted in step 202 to generate the derivatized forms corresponding to the steroids present in the sample, the reaction products can then be ionized (e.g., via an ion source) as shown in step 204 and subjected to DMS so as to separate the ionized derivatized steroids based on their differential mobilities. Though steroid isomers of an isomeric pair may not exhibit any, or significant, differences in their ion mobilities such that they can be separated by the DMS in their native form (i.e., both forms of steroid isomers would be simultaneously transmitted by the DMS), the covalent bonding of the derivatizing reagent to the steroids in step 202 can form derivatized steroids that exhibit sufficient differences in their molecular structures such that they can be resolved under certain DMS conditions due to different mobilities in accordance with various aspects the present teachings. As will be discussed in detail below, for example, the separation voltage (SV) and the compensation voltage (CoV) in the DMS can each be set to particular values such that the ionized derivatized steroid corresponding to a first steroid of isomeric pair can be transmitted from the DMS in higher abundance relative to the ionized derivatized steroid corresponding to the second steroid in the isomeric pair, e.g., most of which can be neutralized at the electrodes of the DMS (step 206). At these first values for CoV and SV, ions transmitted from the DMS can then be detected in step 208. In some aspects, one of the SV and the CoV can then be adjusted so as to selectively transmit the ionized derivatized steroid corresponding to the other steroid of the isomeric pair (step 210), with the ions transmitted from the DMS under these different DMS conditions being detected as in step 212. Based on the results of the detections in steps 208 and 212, for example, the relative proportion of the steroids and/or their quantity in the sample can then be determined in step 214 because the mixture of derivatized products that is ionized in step 204 should also be in the same proportion as the respective steroids present in the sample.

### EXAMPLES

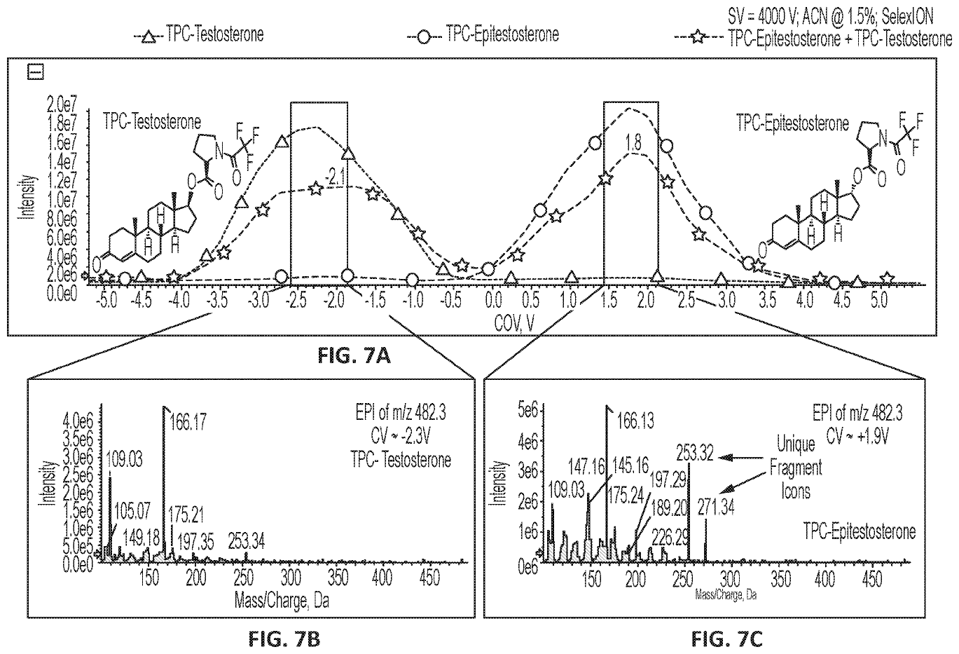

The applicant's teachings can be even more fully understood with reference to the following examples and data presented in FIGS. 7A-C and 8A-E, which demonstrate the separation of sample stereoisomeric steroids and constitutional isomeric steroids using differential mobility spectrometry in accordance with various aspects of the teachings herein. Other embodiments of the applicant's teachings will be apparent to those skilled in the art from consideration of the present specification and practice of the present teachings disclosed herein. It is intended that these examples be considered as exemplary only.

### Example 1

With reference first to FIGS. 7A-C, exemplary data are depicted demonstrating the separation of testosterone and epitestosterone using differential mobility spectrometry. As discussed above with reference to FIGS. 3A and 3B, testosterone and epitestosterone are stereoisomers relative to one another because they exhibit the same molecular formula and sequence of bonded atoms, but differ in the spatial distribution of a hydroxyl functional group. Though conventional mass spectrometry methods and systems may have difficulty resolving these stereoisomers due to their identical mass-to-charge ratios, reduced ionization efficiency, and/or the lack of unique diagnostic fragment ions, for example, methods and systems in accordance with various aspects of the present teachings can allow for improved resolution between these steroid stereoisomers by derivatizing the testosterone and epitestosterone within a sample with enantiomerically-pure S-(−)-N-(trifluoroacetyl)prolyl chloride (i.e., S-TPC). FIG. 7A depicts the ionograms for three samples. In particular, one sample contained a mixture of testosterone and epitestosterone (identified by a star), while the other two samples contained only testosterone (triangle) and only epitestosterone (circle). Each sample was derivatized with S-TPC, ionized using a Turbo V ion source (SCIEX, Concord, ON) and then subject to differential mobility spectrometry. The differential mobility spectrometer (SelexION™, SCIEX, Concord, ON) was operated at a separation voltage (SV) of 4000V, a DMS temperature (DT) of 150 degrees Celsius, and with acetonitrile at 1.5% as the chemical modifier in the drift gas, as the compensation voltage (CoV) applied to the DMS was scanned from about −5.0 V to about +5.0V DC. The DMS was mounted on a 5500 QTRAP® system (SCIEX), with the total ion intensity (y-axis) reflecting the count of ions transmitted by the DMS at each CoV.

As shown in FIG. 7A, the curve for the sample containing the mixture of the derivatized, ionized testosterone and epitestosterone (star) exhibits two distinct CoV peaks at −2.3 V and +1.9 V. However, each sample containing only one of the derivatized, ionized steroids exhibits only a single peak centered at either −2.3 V (triangle) or +1.9 V (circle) during the CoV scan. It will be appreciated in light of FIG. 7A, for example, that the CoV can thus be selected such that only one of the derivatized, ionized steroid isomers are transmitted to the downstream mass spectrometer, and can then be subject to further analysis.

This is further confirmed by the mass chromatograms of FIGS. 7B and 7C, which depict the m/z ratios of the fragmentation products of the ions of m/z 482.3 transmitted by the DMS and generated by the 5500 QTRAP® MS system operated in EPI mode. The MS² spectra of FIG. 7B, for example, depicts the fragment ions of m/z 482.3 derivatized testosterone precursor ions during the CoV window of −2.5V to −1.8V, while the spectra of FIG. 7C depicts the fragment ions of m/z 482.3 derivatized epitestosterone precursor ions are being transmitted from +1.5V to +2.3V. As shown, the MS² spectra of FIG. 7C contains unique fragment ions for the derivatized epitestosterone at m/z 253 and 271 relative to that of the derivatized testosterone, which can be further used to resolve, analyze, and/or quantify the derivatized steroids in accordance with various aspects of the present teachings.

### Example 2

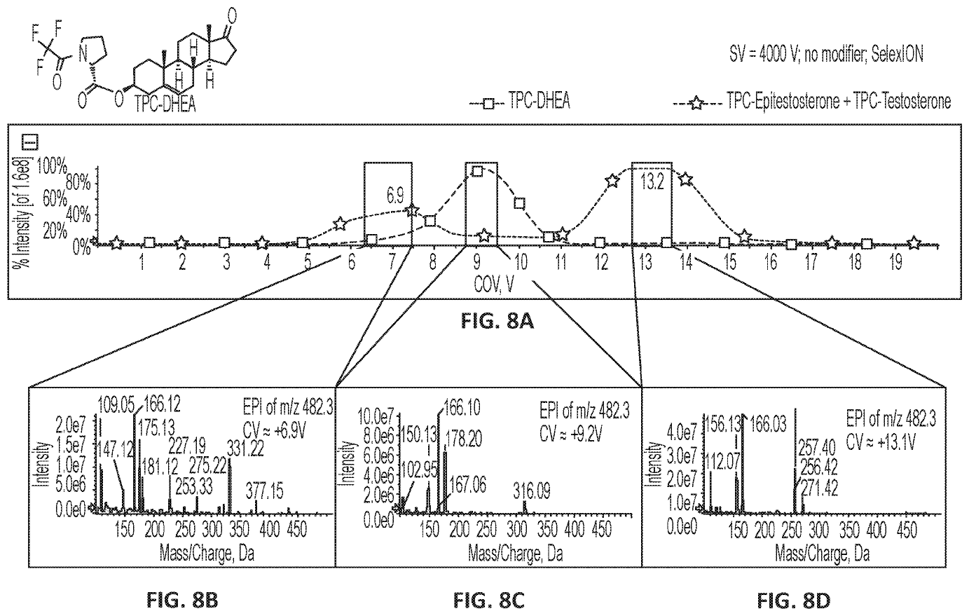

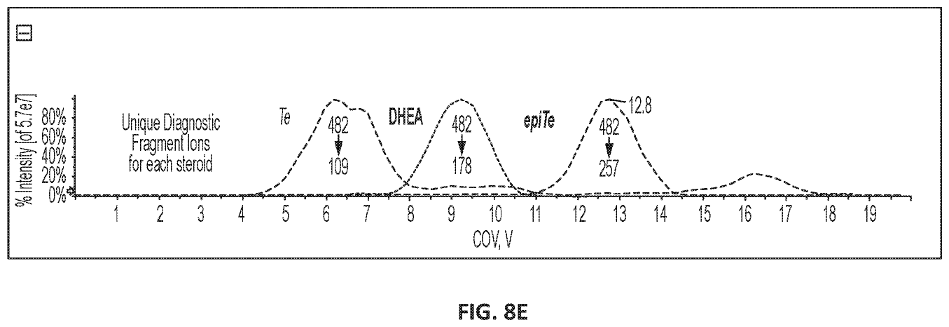

With reference now to FIGS. 8A-E, exemplary data are depicted demonstrating the separation of the stereoisomers testosterone and epitestosterone from one another, as well as from DHEA, which is a constitutional isomer to both testosterone and epitestosterone as discussed above with reference to FIGS. 3A-C. In particular, FIGS. 8A-E demonstrate the ability of methods and systems in accordance with the present teachings to resolve these steroid isomers despite their identical mass-to-charge ratios. FIG. 8A depicts the ionograms for two samples: i) a mixture of testosterone and epitestosterone (identified by a star); and ii) a sample containing only DHEA (triangle) and only DHEA (square). Each sample was derivatized with S-TPC, ionized using a Turbo V ion source (SCIEX, Concord, ON), and then subject to differential mobility spectrometry. The differential mobility spectrometer (SelexION™, SCIEX, Concord, ON) was operated at a separation voltage (SV) of 4000V, DMS temperature (DT) of 150 degrees Celsius, and without a chemical modifier in the drift gas, as the compensation voltage (CoV) applied to the DMS was scanned from about 0.0 V to about +20.0V DC. The DMS was mounted on a 5500 QTRAP® system (SCIEX), with the total ion intensity (y-axis) reflecting the count of ions transmitted by the DMS at each CoV.

As shown in FIG. 8A, the curve for the sample containing the mixture of the derivatized, ionized testosterone and epitestosterone (star) exhibits two distinct CoV peaks at −6.9 V and +13.1 V. The identity of the unique fragment ions in the MS² chromatograms of the precursor m/z 482.3 of FIG. 8B (CoV window of +6.4 V to +7.4 V) and 8D (CoV window of +12.6 V to +13.6 V) confirm that the derivatized testosterone and epitestosterone can be resolved under these DMS conditions in accordance with the present teachings. In addition, FIG. 8A also depicts a third distinct peak corresponding to the TPC-derivatized DHEA in the second sample, which as shown in FIG. 8C also exhibits a unique fragment ion (m/z 178) of the precursor m/z 482.3. In sum, FIG. 8E depicts the multi-factor resolution that can be achieved by tuning the differential mobility spectrometer to select for particular precursor ions corresponding to the steroid stereoisomers and/or constitutional isomeric steroids, and then performing additional MS on the ions transmitted from the DMS during the CoV scan.

The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

1. A method of analyzing a sample containing or suspected of containing at least one isomeric steroid, comprising:
reacting, if present, each isomeric steroid with a derivatizing reagent so as to form derivatized steroids corresponding to each isomeric steroid;
ionizing said derivatized steroids so as to form ionized derivatized steroids; and
transporting said ionized derivatized steroids through a differential mobility spectrometer to effect separation of said ionized derivatized steroids corresponding to each isomeric steroid from another isomeric steroid in sample.

2. The method of claim 1, further comprising detecting the ionized derivatized steroids transported from the differential mobility spectrometer at a first combination of compensation voltage and separation voltage and at a second combination of compensation voltage and separation voltage applied to the differential mobility spectrometer, wherein the first combination is configured to optimize transmission of a first ionized derivatized steroid corresponding to a first steroid of an isomeric steroid pair and the second combination is configured to optimize transmission of a second ionized derivatized steroid corresponding to a second steroid of the isomeric steroid pair.

3. The method of claim 2, further comprising determining the relative abundance in the sample of the first and second steroids of the isomeric steroid pair.

4. The method of claim 1, wherein the sample contains at least two steroids that are isomers of one another.

5. The method of claim 4, wherein each of the at least two steroids are constitutional isomers relative to the other.

6. The method of claim 4, wherein each of the at least two steroids are stereoisomers relative to the other.

7. The method of claim 1, wherein said derivatizing reagent is an acyl halide.

8. The method of claim 7, where said derivatizing reagent is one of S-(−)-N-(trifluoroacetyl)prolyl chloride and R-(−)-N-(trifluoroacetyl)-propyl chloride.

9. The method of claim 1, where said derivatizing reagent comprises a substituted proline betaine.

10. The method of claim 9, wherein the substituted proline betaine is of the formula:

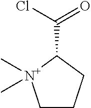

11. The method of claim 9, wherein the substituted proline betaine is of the formula:

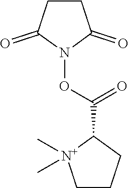 [SMILES: C[N+]1(C)CCC[C@H]1C(=O)ON1C(=O)CCC1=O]

12. The method of claim 1, wherein said steroid comprises a hydroxyl group and wherein said step of reacting each steroid with the derivatizing agent comprises replacing a hydrogen of the hydroxyl group of the steroid with at least a portion of the derivatizing agent.

13. The method of claim 1, wherein a compensation voltage and a separation voltage are applied to the differential mobility spectrometer so as to selectively transmit one of said ionized derivatized steroids.

14. The method of claim 13, further comprising scanning the compensation voltage while maintaining the separation voltage.

15. The method of claim 13, further comprising adjusting at least one of the compensation voltage and the separation voltage after a first duration so as to selectively transmit another of said ionized derivatized steroids for a second duration.

16. The method of claim 1, further comprising adding a chemical modifier to a drift gas for transporting said ionized derivatized steroids through the differential mobility spectrometer.

17. The method of claim 16, wherein the chemical modifier is selected from the group consisting of water, methanol, isopropanol, acetonitrile, and acetone.

18. The method of claim 1, wherein the differential mobility spectrometer comprises High-Field Asymmetric Waveform Ion Mobility Spectrometry (FAIMS).

19. A method of analyzing a sample containing or suspected of containing at least one at least one steroid of an isomeric steroid pair, comprising:
transporting one or more ionized derivatized steroids each of which is derived from a single steroid of the isomeric steroid pair through a differential mobility spectrometer to effect separation of the one or more ionized derivatized steroids.

20. The method of claim 19, wherein the one or more ionized derivatized steroids comprise a first ionized derivatized steroid corresponding to a first steroid of the isomeric steroid pair and a second ionized derivatized steroid corresponding to a second steroid of the isomeric steroid pair, the method further comprising determining the relative abundance in the sample of the first and second steroids based on the relative abundance of the first and second ionized derivatized steroids following the differential mobility separation.
